(19) United States
(12) Patent Application Publication
(10) Pub. No.: US 2006/0049176 A1
(43) Pub. Date: Mar. 9, 2006

(54) Food cooking vessel with outer ornaments

(76) Inventor: Francesco Ferron, Cremona (IT)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 11/214,285

(22) Filed: Aug. 29, 2005

(30) Foreign Application Priority Data
Sep. 1, 2004 (IT) MI2004A-001688

(51) Int. Cl. H05B 6/12

(52) U.S. Cl. 219/621

(57) ABSTRACT

A food cooking vessel comprises outer colored ornaments or wordings operating as signaling symbols, wherein the color of the ornaments of wordings is made of a thermochromatic paint which, as the vessel is heated, changes its color in a well visible manner by a user of the cooking vessel.

### BACKGROUND OF THE INVENTION

The present invention relates to a food cooking vessel with outer ornaments or wordings.

As is known in the prior art, food cooking vessels are conventionally made of metal materials, in particular aluminium. These aluminium vessels are coated, on the outer surface thereof, by a paint layer, both to protect the metal material from an undesired oxidation and for allowing the vessel to be easily cleaned, as it is washed, for example in a dishwashing machine.

The aesthetic aspect of the above mentioned cooking vessel is conventionally improved by screen printing, buffering or transfer printing methods, for applying different types of ornaments or wordings which can comprise decorating lines, flower patterns or fancy geometric figures for providing an aesthetically pleasant vessel.

A drawback affecting prior food cooking vessels, however, is that a user cannot precisely detect the temperature achieved in or by the cooking vessel arranged on a heating source and, accordingly, she/he does not know if the vessel has achieved a proper temperature for providing the desired cooking operation; moreover, a very hot cooking vessel would be susceptible to burn the user.

### SUMMARY OF THE INVENTION

Accordingly, the aim of the present invention is to overcome the above mentioned drawback of the prior art and provide a food cooking vessel suitable to signal an heated condition or an accurate temperature thereof.

This aim is achieved by a food cooking vessels, made of a metal material, advantageously aluminium, which is coated on an outside surface thereof by a paint layer and enhanced by ornament patterns, respectively signaling wordings, and being characterized in that said ornament patterns, respectively said wordings, are made of thermochromatic pigment containing materials.

Accordingly, by way of an example, it is possible to provide a food cooking vessel coated on its outer surface by a paint having a light grey color, and apply, on this coating, different color, for example black, ornaments, respectively signaling wordings or symbols, of like color, and adapted, owing to their thermochromatic pigment contents, to change their colors as a given operation temperature is achieved, thereby providing modified, such as red or orange, color ornaments, respectively signaling wordings.

### BRIEF DESCRIPTION OF THE DRAWINGS

The subject matter of the present invention will be disclosed in a more detailed manner hereinafter, with reference to an embodiment thereof, given only by way of an indicative example and shown in the accompanying drawings, where:

FIG. 1 shows a food cooking vessel including a ring or loop ornament or decoration;

FIG. 2 shows a food cooking vessel including a parallel line ornament;

FIG. 3 shows a food cooking vessel bearing the wordings: “take care, the temperature is 120° C.”;

FIG. 4 shows a cold food cooking vessel bearing thermochromatic paint wordings or symbols (which can be seen only in a hot condition); and

FIG. 5 shows some symbols with a signaling contents related to the user safety and which can be seen in a hot status of the vessel.

### DESCRIPTION OF THE PREFERRED EMBODIMENTS

As is shown in the figures, the food cooking vessel, indicated by the reference number 1, comprises a vessel handle 2 and a vessel bottom 3 which is arranged, for cooking food products, on a heating source which can comprise a gas burner, a metal electrically heated plate, or a ceramics plate.

The metal vessel 1, advantageously made of aluminium, comprises an outer coating 4 which can be constituted by a paint layer applied, for example, by a spraying method.

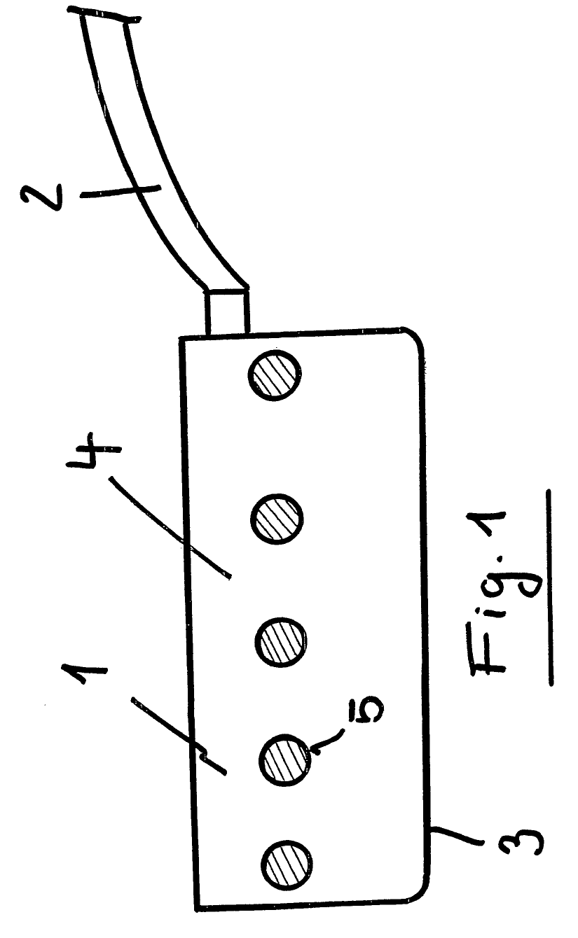

On said layer 4 ornaments or decorations 5 are applied, which can comprise fancy ornaments, such as flower ornaments or geometric patterns, such as a series of loops or rings, as shown in FIG. 1.

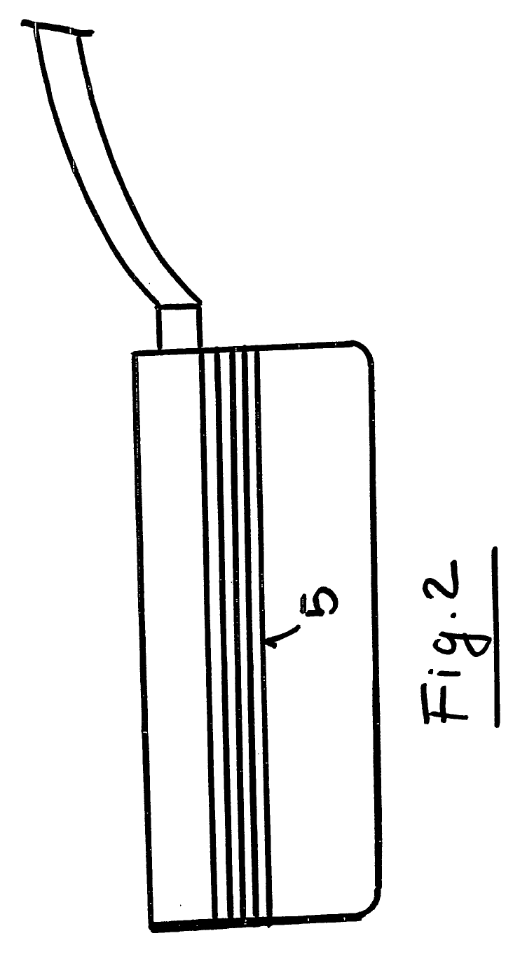

The ornaments 5 can also comprise parallel lines, as shown in FIG. 2.

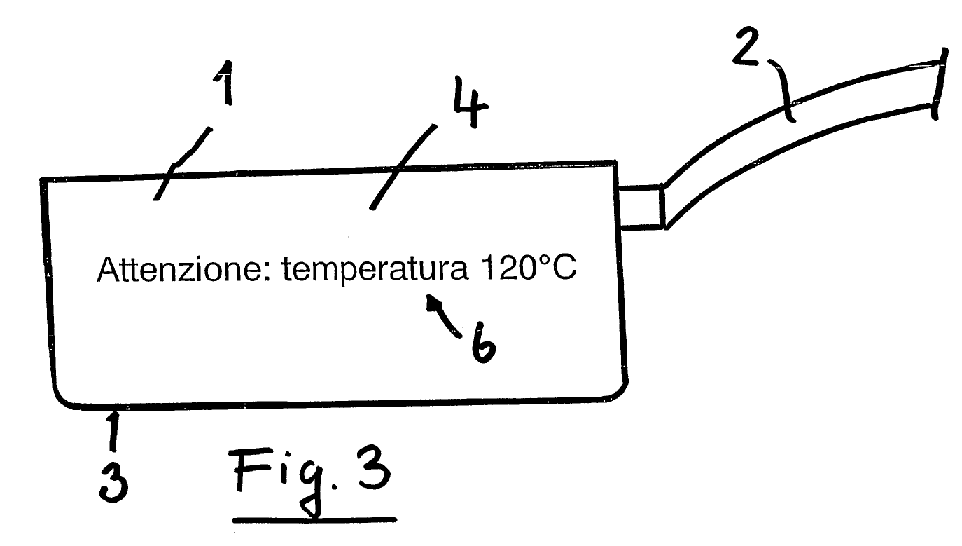

FIG. 3 shows that the cooking vessel 1 comprises, on its outer surface 4, constituted by a heat resistant paint layer, additional signalling wordings, indicated by the reference number 6 and which, for example, read as follows: “take care: temperature of 120° C.”.

Both the geometric ornaments 5, shown in FIGS. 1 and 2, and the signaling wordings 6, shown in FIG. 3, are made of thermochromatic pigment containing paints.

Owing to the use of thermochromatic paints, the ornaments 5 can be so selected that, in a cold or warm condition of the cooking vessel 1, they would assume a “cold” color, such as green or blue, whereas, as the cooking vessel achieves its operation temperature, the ornaments 5, respectively the wordings 6, would change their color for example to a “hot” color, such as a bright red or orange color, thereby signalling to the cooking vessel user that the vessel has achieved a heating condition suitable for performing the food product cooking, while signalling that said cooking vessel 1 has achieved a temperature which would be dangerous since, in a case of an accidental contact, it would burn the cooking vessel user.

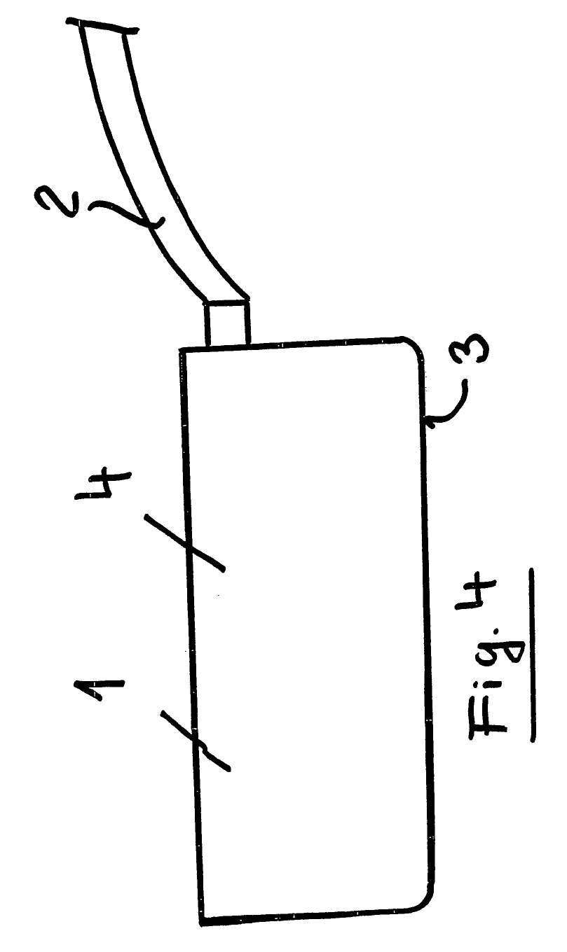

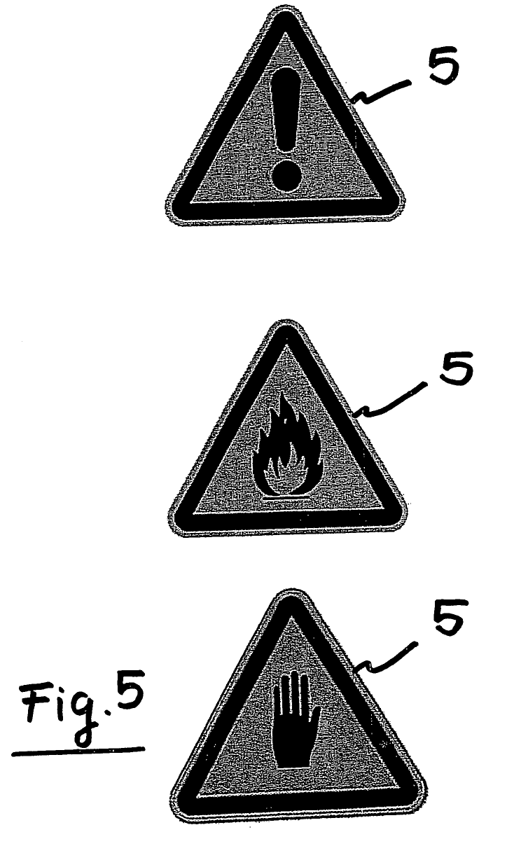

As shown in FIG. 4, the cooking vessel 1 can also comprise an outer coating 4. Advantageously, the wordings or signalling symbols will have the same color as that of the outer coating 4 and, accordingly, with a cold cooking vessel, said wordings or symbols, as shown in FIGS. 4 and 5, would not be visible.

Only as the cooking vessel 1 is heated or hot, the signaling wordings or symbols, owing to the mentioned thermochromatic pigment holding products, will become visible, as is shown in FIGS. 1, 2 and 3.

The ornaments or decorations 5, respectively the signalling wordings 6, could be applied to the cooking vessel 1 by different methods, as known in the prior art, such as screen printing, transfer printing, buffering printing or the like methods.

The ornaments 5 and wordings 6 can be advantageously protected by applying thereto a clear and heat resistant paint layer, thereby additionally protecting said ornaments 5 and signalling wordings 6 against aggressive agents, such as cleansing materials, used in a dishwashing machine.

1. A food cooking vessels (1), made of a metal material, advantageously aluminium, which is coated on an outside surface thereof by a paint layer (4) and enhanced by ornament patterns (5), respectively signaling wordings (6), and being characterized in that said ornament patterns (5), respectively said wordings (6), are made of thermochromatic pigment containing materials.

2. A food cooking vessel, according to claim 1, characterized in that said signaling wordings or symbols (6) have, in a cold condition of said cooking vessel (1), a same color as that of an outer coating (4) of said cooking vessel (1) and, in a heated vessel (1) condition, having a color well visible by an user of said cooking vessel.

3. A food cooking vessel, according to claim 2, characterized in that the paint (5, 6) forming said thermochromatic pigment holding wordings or symbols assumes, as said cooking vessel (1) is heated, a red or orange color.

4. A food cooking vessel, according to claim 1 characterized in that said ornaments (5) and signalling wordings (6) are covered by a heat and aggressive agent resistant clear paint layer.

5. A food cooking vessel, according to claim 1, characterized in that said ornaments (5) have, with the cooking vessel (1) being in a cold condition, a color similar to that of said outer coating (4) and that, with the cooking vessel (1) being in a hot condition, said ornaments assume a visible color contrasting against the color of the cooking vessel coating (4).
